(19) United States
(12) Patent Application Publication
(10) Pub. No.: US 2018/0002841 A1
(43) Pub. Date: Jan. 4, 2018

(54) SHED FORMING DEVICE WITH VENTILATION MEANS

(71) Applicant: NV MICHEL VAN DE WIELE, Kortrijk/Marke (BE)

(72) Inventor: Stefaan VANHEESBEKE, Ledegem (BE)

(21) Appl. No.: 15/542,038

(22) PCT Filed: Dec. 22, 2015
(86) PCT No.: PCT/IB2015/059877

§ 371 Date: Jul. 6, 2017

(30) Foreign Application Priority Data
Jan. 7, 2015 (BE) 2015/5002

(51) Int. Cl. D03C 3/28; D03J 1/00; H01F 7/06; F24F 11/00

(52) U.S. Cl. CPC D03C 3/28; D03J 1/008; D03J 1/002; H01F 7/066; F24F 11/0001

(57) ABSTRACT

A shed forming device for a weaving machine, comprising a working space (3) in which shed forming systems having selection means for the positioning of warp threads are provided, and ventilation means (7) to create an air flow (A) in this working space (3), wherein the ventilation means (7) interact with regulating means (8, 9, 10) for automatically regulating the air flow rate as a function of at least one of the following measured parameters: the flow rate and the velocity of the air flow (A) and the air pressure in the working space (3). As a result, the air flow rate can be rapidly adapted to changing conditions and can always be appropriate for efficient cooling and for creation of an overpressure.

This application claims the benefit of Belgian patent application No. 2015/5002, filed Jan. 7, 2015, which is hereby incorporated by reference in its entirety.

### FIELD OF INVENTION

A shed forming device for a weaving machine, comprising an at least partially enclosed working space in which a series of shed forming systems having associated selection means for the positioning of warp threads are provided, and ventilation means to create an air flow in the working space.

### BACKGROUND

In EP 1 069 218 B1 a shed forming device of this type for a weaving machine is described. The selection means comprise a series of electrical actuators, which form two panels and are fed and controlled from a supply unit and a control unit which are accommodated in a compartment formed between these panels. A ventilation unit generates a cooling air flow having a constant flow rate through the compartment in order to keep the temperature of the supply unit, the control unit and the actuators under control.

The resistance encountered by the air flow gradually increases during operation of the shed forming device, for example as a result of contamination of air channels or filters, and this ensures a gradual reduction of the air flow rate in the area around the shed forming means. In order to avoid a situation in which the effect of the air flow hereby rapidly becomes inadequate, a ventilation unit which generates an air flow having a flow rate which initially is much higher than necessary must be provided.

This high flow rate brings, however, raises a number of significant drawbacks. Weaving machines are generally installed in a very dusty environment, and it is known that accumulations of dust can produce an overheating and/or a malfunctioning of the shed forming device, resulting in a faulty positioning of the warp threads. In order to reduce the amount of dust as much as possible in the area around the shed forming means, the air flow will first be passed through a dust filter. The high flow rate of the air flow results in this dust filter having to be cleaned or replaced quite frequently.

Moreover, a certain amount of fine dust cannot be retained by the dust filter. As a result of the high flow rate of the air flow, the flow rate of this fine dust passed through is also quite large, so that, within a short time, a great deal of dust can still end up close to the shed forming means.

When the weaving machine is started, warm and moist air is forced into the space in which the relatively colder parts of the shed forming device are located. As a result, condensation occurs. This disadvantageous effect is also further reinforced by the high flow rate of the generated air flow. The over-high rotation speed of the ventilation unit also of course increases the energy consumption and is detrimental to the service life of the fan.

Shed forming devices of this type are frequently provided with a temperature detector in order to automatically switch off the weaving machine when the temperature exceeds a preset limit value. Self-evidently, the switching-off of the weaving machine is detrimental to the productivity of the weaving machine. In order to avoid these switching-offs in all operating conditions, a flow rate which offers a solution for the worst operating conditions will hence be set. Here too, the generated flow rate will initially be much larger than required.

### SUMMARY

An object of some embodiments of this invention is to provide a shed forming device for a weaving machine, wherein the above-indicated drawbacks of the existing shed forming devices are remedied.

This object may be achieved by providing a shed forming device for a weaving machine, comprising an at least partially enclosed working space in which a series of shed forming systems having associated selection means for the positioning of warp threads are provided, and ventilation means to create an air flow in the working space, wherein, according to this invention, the ventilation means interact with regulating means for automatically regulating the air flow rate as a function of at least one of the following measured parameters,
the flow rate of the said air flow,
the velocity of the said air flow,
the air pressure in the working space.

The flow rate of the air flow created by the ventilation unit is thus regulated as a function of the flow rate and/or the velocity of the created air flow and/or as a function of the air pressure which is measured in the working space. These parameters vary quite rapidly with changing conditions, such as the increasing contamination of a filter. This in contrast to temperature, which is a rather slowly changing parameter. As a result, the flow rate of the created air flow can always be rapidly adapted to changing conditions, so as to obtain in the working space, and thus in the area around the shed forming means, an air flow having a flow rate which is only a little larger than necessary to cool efficiently and/or to create overpressure.

The selection means are located in the said working space. These selection means contain, for example, electrical actuators and/or other electrical components which develop heat during use. The cooling effect of the air flow prevents the temperature in the working space, and consequently also the temperature of the electrical components, from rising too high.

In the working space, an environment for the shed forming means is created in which the above-indicated measured parameters can be more easily kept under control and assume quite uniform values. The measurement of a parameter at a particular place within the working space will thus be more or less representative of the entire working space. The regulation thereby becomes more reliable. Since the working space is wholly or partially enclosed, the dust can also more easily be kept outside it.

The measurement of a parameter does not necessarily mean that the value of this parameter is determined. Also the detection of whether a parameter is above or below a defined limit value is regarded, within the context of this invention, as ‘the measurement’ of this parameter.

The variation of one or more of the said parameters, when valuated at two different places, can also be used as a control parameter. The size of the difference between the air pressure at two different places of the device can thus be measured, for example. Preferably, the pressure difference between two places on either side of a filter is taken. This difference, the pressure drop across the filter, is a measure of the contamination of the filter. We here assume that the determination of a variation of one of the said parameters implies that this parameter is also measured. The detection of whether such a parameter variation is above or below a certain limit value is also regarded as the measurement of the parameter.

One of the said parameters can also be measured at two or more different places in the working space, the air flow rate then being regulated as a function of a value calculated on the basis of these different measurement values, for example the mean value of these measurements. Other known regulating systems, for example based on several parameters, or based on the variation of one or more parameters over time, are also amongst the possibilities.

The regulation of the air flow rate can be realized by adapting the flow rate created by the ventilation unit. This can be done, for example, by altering the operating speed of one or more air-displacing elements, such as, for example, by adapting the rotation speed of the rotor of a fan, or by altering the position of one or more air-displacing elements or parts thereof, for example by altering the position of the blades of a fan.

Also the switching off and back on of an air-displacing element is regarded as the adaptation of the operating speed thereof, and can result in a regulation of the air flow rate. In particular, a ventilation unit can comprise two or more air-displacing elements and the air flow rate can be regulated by altering the number of simultaneously acting air-displacing elements.

The air flow rate can also be regulated by not directing or conducting a changeable part of the created air flow to the area around the shed forming means. This can be realized, for example, with an automatically adjustable regulating valve, which, depending on its position, enables a smaller or larger part of the air flow to pass through to the shed forming means.

In a preferred embodiment of this shed forming device, the shed forming device also comprises means for measuring the temperature in the working space, and the regulating means are provided to regulate the air flow rate as a function of the temperature in the working space.

The working space is, for example, enclosed by the walls of a substantially closed housing. The ventilation means can also be accommodated in the housing and can be provided to suck in air via an air passage in the wall of the housing. A dust filter can be placed in this air passage. Preferably, it is ensured that the air is displaced substantially according to a well-defined displacement direction through the working space, for example from top to bottom, and subsequently leaves the working space again. In so doing, this air flow transports at least a part of the present dust outside the working space. The risk of dust accumulations which can disturb or prevent the correct working of the shed forming means is thus diminished.

Preferably, between the shed forming systems and/or between the selection means a number of passages are provided, along which the air flow can be displaced according to the said direction of displacement, preferably from top to bottom. These passages preferably have virtually the same width and length. In the different passages, parallel air flows having virtually the same flow rate, and thus also virtually the same effects, are then obtained.

In a particularly preferred embodiment, the shed forming device comprises means to measure the temperature of one or more selection elements or of one or more carriers on which one or more selection elements are fastened, and the regulating means are provided to regulate the air flow rate as a function of the temperature of the one or more selection elements or carriers. Thus the temperature can be measured, for example, of one or more printed circuit boards, each carrying a number of selection elements.

In another preferred embodiment of this shed forming device, the regulating means are also provided to regulate the air flow rate during the weaving as a function of the predefined selection frequency of a group of selection elements during a future period of the ongoing weaving process.

Indeed, the weave pattern of the fabric to be woven determines the selection frequency of each selection element, and this is, of course, fixed in advance.

The temperature of each selection element depends, inter alia, on the frequency of the selections realized thereby. An increase or decrease of this selection frequency will consequently bring about a more or less proportional increase or decrease of the temperature. By making an analysis of the weave pattern, it is possible to determine how the selection frequency of the selection elements present in the working space will evolve during a defined future period of the weaving process. This analysis can, of course, be automated.

By regulating the air flow rate as a function of the future selection frequencies of the selection elements, it is possible to anticipate an expected increase or decrease in the temperature. This enables the cooling to be very efficiently regulated as a function of future changing conditions. In this way, the temperature fluctuations in the working space can be minimized still further.

In yet another embodiment of the shed forming device, the latter is provided to measure the velocity and/or the flow rate of the said air flow in the working space or in the area around the ventilation means.

In a preferred embodiment of the shed forming device, the air flow created by the ventilation means can give rise to an overpressure in the said working space. As a result of this overpressure, still less dust will be able to make its way into the working space.

In a particularly preferred embodiment, the ventilation means comprise at least one rotatable air-displacing element, and the air flow rate is automatically regulatable by automatically altering the rotation speed of at least one air-displacing element as a function of a control parameter. The said rotatable air-displacing element is preferably a bladed rotor.

If two or more rotating air-displacing elements are provided, the regulation of the air flow rate can also mean that the number of simultaneously rotating air-displacing elements is defined as a function of a control parameter.

In another possible embodiment, the ventilation means comprise at least one fan having a rotor comprising one or more blades, the position of which is changeable, and the air flow rate is automatically regulatable by automatically altering the position of at least one of the blades as a function of a control parameter.

The shed forming device can as an additional protection also further comprise a temperature detector, which is arranged in the area around the shed forming device and interacts with a control device, wherein the control device is provided to switch off the weaving machine when the temperature exceeds a preset limit value.

### BRIEF DESCRIPTION OF THE DRAWINGS

In the following, a more detailed description is given of a possible embodiment of a shed forming device having a ventilation device according to this invention. The sole aim of this detailed description is to indicate how the invention can be realized and to illustrate the particular characteristics thereof and thus clarify these still further. This description can thus not be regarded as a limitation of the scope of this patent protection. Nor can the field of application of the invention be limited on the basis of this description. In this description, reference is made through reference numerals to the accompanying figures, wherein

FIG. 1 is a side view of a shed forming device accommodated in a housing and having a ventilation device according to this invention, and

FIG. 2 is an enlarged representation of that portion of the shed forming device which in FIG. 1 lies within the bordered region (X).

### DETAILED DESCRIPTION

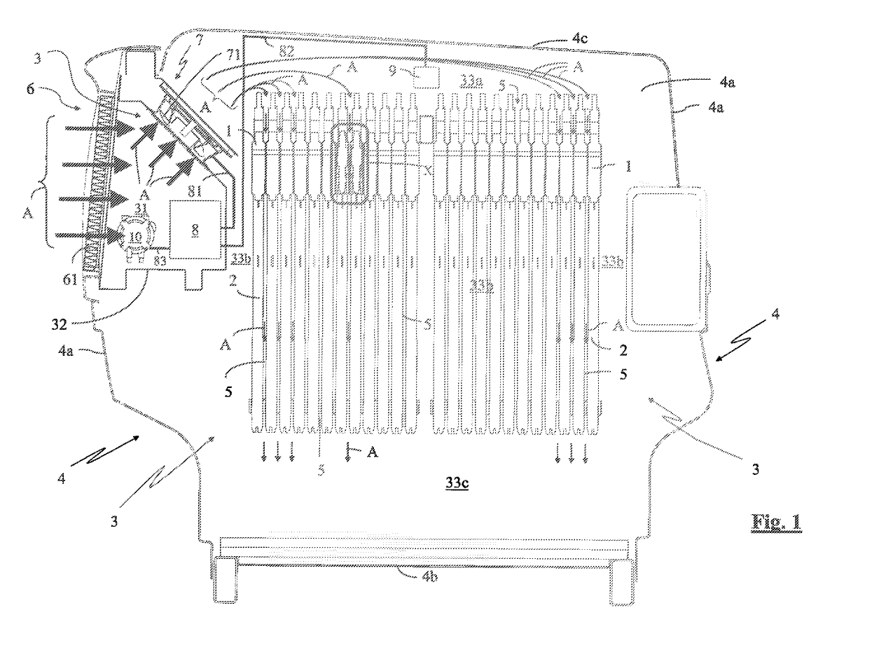

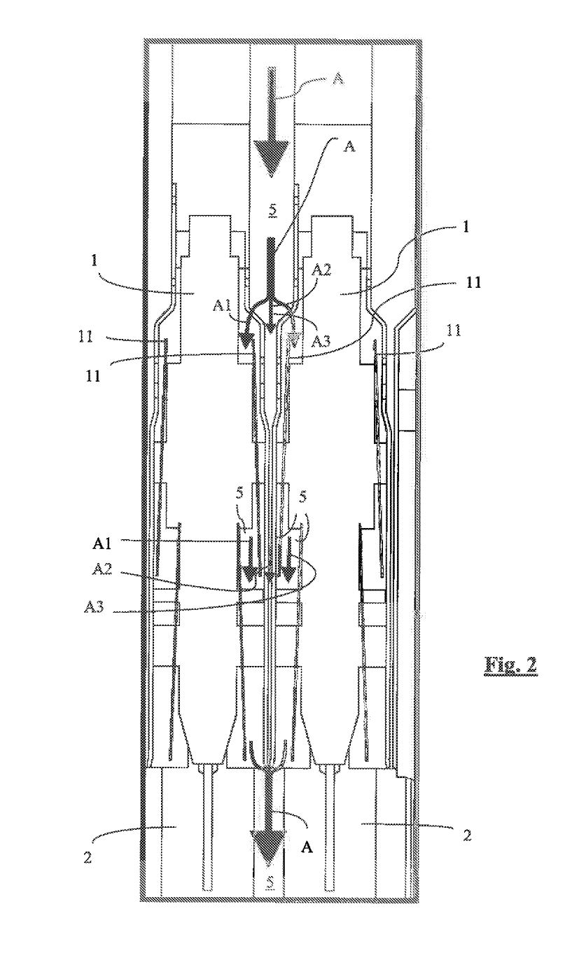

The shed forming device represented in FIG. 1 comprises a large number of shed forming systems of the type comprising two interacting flexible hooks (11) (see FIG. 2), which are provided to be moved up and down in opposite phase by a respective knife (not represented in the figures), and which can also be selected by means of a respective electromagnetic actuator so as to be kept at a fixed height during selection. Other known shed forming systems comprise non-flexible hooks and flexible lamellae, wherein the hooks, in the selection process, get caught on a flexible lamella at a fixed height. The actuators of all shed forming systems are contained in removable modules (1), hereinafter referred to as selection modules (1). In each selection module (1) are, for example, 24 to 192 actuators, preferably 48 to 144, for example 96, actuators.

The vertical hook motions are transmitted in each shed forming system in known manner via a hoist device, consisting of pulley cords and a pulley element, to one or more harness cords, which are connected to a respective heddle comprising a heddle eye. One or more warp threads extend through the heddle eye. The heddles and the warp threads are not represented in the figures. The pulley cords and the pulley elements of all shed forming systems are contained in removable pulley modules (2). For each pulley module (2) there are also provided, for example, 24 to 192 pulley devices, preferably 48 to 144, for example 96 pulley devices.

Each shed forming system interacts with a respective electromagnetic actuator, with which each hook (11), according to choice, can be selected to be kept at a fixed height, for example by displacement or bending of the hook (11) into a position in which it hooks onto a restraining means. The pulley cords and pulley elements of each pulley module (2) here interact with the actuators and the associated hooks (11) of a respective selection module (1). In the figures, the interacting selection modules (1) and pulley modules (2) are represented vertically below one another. Here, only the outlines of the modules (1), (2) are represented schematically.

Between the different sets of interacting modules (1), (2) in the working space (3), one and the same small horizontal gap is respectively left, whereby virtually identical vertical passages (5) for the cooling air flow are formed between these modules.

Through the appropriate selection or non-selection of one of the two hooks (11) or of both hooks (11) of each shed forming system, the warp threads in each weaving cycle are positioned such that a shed is formed between the warp threads, in which shed the warp threads take the required position so as to have the desired position in the fabric after the introduction of a weft thread.

The different selection modules (1) with associated hooks (11) and their respective associated pulley modules (2) are arranged side by side in a working space (3) enclosed by a housing (4) having four side walls (4a), a floor (4b) and a hinged lid (4c). The place of the operator of the weaving machine is on the left-hand side of the housing (4) represented in FIG. 1. The side wall (4a) of the housing (4) which is located on this left-hand side is thus the front side.

The side wall on the right-hand side of the housing (4)—which would be at the front in the figure—has been removed in order to reveal the shed forming device inside the working space (3).

An opening is provided in the front side (4a) of the housing (4), which opens out into a front chamber (31) separated by closed walls (32) from the larger, central chamber (33) of the working space (3), the space in which the shed forming systems are found.

In this opening, a dust filter (6) is fastened with an air passage in which filter material (61) is placed. In the central chamber (33) of the working space (3), we distinguish a middle part (33b), namely that zone of the central chamber (33) in which the selection modules (1) and the pulley modules (2) are located, a top part (33a), namely that zone above the said selection modules (1) which is bounded at the top by the lid (4c), and a bottom part (33c), namely that zone which is located below the pulley modules (2) and is bounded at the bottom by the floor (4b) of the housing (4).

In the said wall (32) which forms a partition between the front chamber (31) and the central chamber (33) of the working space (3) a fan (7) is placed. The fan (7) comprises a rotatable set of blades (71) and has a controllable rotation speed, and is provided to displace air from the front chamber (31) to the top part (33a) of the central chamber (33) of the working space (3). As a result, an underpressure is formed in the front chamber (31), through which ambient air is sucked in from outside the housing (4) via the filter (6). The air flow (A) is represented in FIG. 1 by means of arrows.

As a result, an overpressure is created in the top part (33a) of the central chamber (33) of the working space (3), whereby the air flow (A) in this central chamber (33) is displaced from the top part (33a), via the said vertical passages (5) between the modules (1), (2) in the middle part (33b), to the bottom part (33c). Via openings (not represented in the figures) in the floor (4b) and/or in the side walls (4a), the air can leave the working space (3) again. As a result of the continuous supply of air from outside the housing (4), an overpressure is formed in the central chamber (33) of the working space (3) inside the housing (4).

The rotation speed of the fan (7) is controlled by a control device (8, 81, 82, 83, 9, 10) (represented schematically), consisting of a control unit (8), which is connected via connectors or conductors (81), (82), (83)—or wirelessly—to the fan (7), and two sensors (9), (10). The control unit is arranged in the front chamber (31) and is connected, for example via a cable (81), to the fan (7).

Centrally in the top part (33a) of the central chamber (33) of the working space (3) a sensor (9) is arranged, which is provided to measure the pressure in this top part (33a) of the central chamber (33) and to continuously or at defined intervals send a signal representative of the magnitude of the measured value to the control unit (8), via the cable (82)2.

The sensor (9) can be arranged anywhere in the central chamber (33), for example in a passage (5) between two selection modules (1a) or between two pulley modules (1b) or in the bottom part (33c).

In the front chamber (31) a sensor (10) is arranged which is provided to measure the velocity or the flow rate of the air flow (A) in the front chamber (31), and to continuously, or at defined intervals, send a signal which is representative of the magnitude of the measured value to the control unit (8) via the cable (83).

The control unit (8) is provided to alter the rotation speed of the fan (7) as a function of the measured air flow velocity or the measured air flow rate in the front chamber (31), and/or as a function of the measured air pressure in the top part (33a) of the central chamber (33) of the working space (3).

More specifically, when the sensor (10) in the front chamber (31) measures a reduced air flow velocity or a reduced air flow rate—for example as a result of the increased presence of dust in the filter material (61)—the control unit (8) will ensure that the rotation speed of the fan (7) is increased until the measured flow velocity or the measured flow rate again reaches the preset target value which is considered sufficient to efficiently cool the selection means (2) and/or create the desired overpressure in the working space (3). Conversely, when an increased flow velocity or flow rate is measured, the control unit (8) will reduce the rotation speed of the fan (7) until the preset target value has been reached again. As a result, the created air flow rate is at all moments adapted to what is necessary to obtain the desired effects in the working space (3).

At the same time, the control unit (8) can either in an alternative setting or in a different embodiment be provided to, when the pressure sensor (9) in the top part (33a) of the central chamber (33) of the working space (3) measures a reduced air pressure, increase the rotation speed of the fan (7) until the measured pressure again reaches the preset target value which is considered sufficient to efficiently cool the selection means (2). Conversely, when an increased pressure is measured, the control unit will reduce the rotation speed of the fan until the preset target value has been reached again.

The measuring instrument can be a detector which sends a signal to the control device when the air velocity or the air pressure or the air flow rate has fallen below a preset minimum value.

In FIG. 2, the air flow (A) is indicated by means of arrows.

The neighbouring selection modules (1) and pulley modules (2) are respectively placed side by side at virtually equal intervals, so that narrow parallel passages (5) are formed with virtually equal transverse dimensions.

As a result, the parallel air flows in these channels have a virtually equal flow rate, whereby the same effects of the air flow are obtained over the whole of the shed forming device.

In the interspace between two neighbouring selection modules (1), the air can be distributed via openings and passages over a plurality of parallel channels, whereby the air flow (A) is split into two or more partial air flows (A1), (A2), (A3). These parallel channels can open out lower down in one and the same channel, so that the partial air flows (A1), (A2), (A3) there finally merge again into one air flow (A), as is represented schematically by means of arrows in FIG. 2.

1. Shed forming device for a weaving machine, comprising an at least partially enclosed working space in which a series of shed forming systems having selectors for the positioning of warp threads are provided, and one or more ventilators to create an air flow in the working space, wherein the ventilators interact with regulators for automatically regulating the air flow rate as a function of at least one of the following measured parameters,
the flow rate of the said air flow
the velocity of the said air flow,
the air pressure in the working space.

2. Shed forming device according to claim 1, characterized in that the shed forming device comprises a temperature measurement apparatus in the working space, and in that the regulators are provided to regulate the air flow rate as a function of the temperature in the working space.

3. Shed forming device according to claim 1, characterized in that the shed forming device comprises a temperature measurement apparatus to measure the temperature of one or more selection elements or of one or more carriers on which one or more selection elements are fastened, and in that the regulators are provided to regulate the air flow rate as a function of the temperature of the one or more selection elements or carriers.

4. Shed forming device according to claim 1, characterized in that the regulators are provided to regulate the air flow rate during the weaving as a function of a predefined selection frequency of a group of selection elements during a future period of the ongoing weaving process.

5. Shed forming device according to claim 1, characterized in that the regulators are provided to measure the velocity and/or the flow rate of the said air flow in the working space or in the area around the ventilators.

6. Shed forming device according to claim 1 characterized in that the air flow created by the ventilators gives rise to an overpressure in the working space.

7. Shed forming device according to claim 1, claims, characterized in that the ventilator comprise at least one rotatable air-displacing element, and in that the air flow rate is automatically regulatable by automatically altering the rotation speed of at least one air-displacing element as a function of a control parameter.

8. Shed forming device according to claim 1, characterized in that the ventilator comprise at least one fan having a rotor comprising one or more blades, the position of which is changeable, and in that the air flow rate is automatically regulatable by automatically altering the position of at least one of the blades as a function of a control parameter.

9. Shed forming device according to claim 1, characterized in that the shed forming device comprises a temperature detector, which is arranged in the area around the shed forming device and interacts with the control device, wherein the control device is provided to switch off the weaving machine when the temperature exceeds a preset limit value.
